(19) United States
(12) Patent Application Publication
(10) Pub. No.: US 2006/0073023 A1
(43) Pub. Date: Apr. 6, 2006

(54) Integrated electromagnetic pump and power supply module

(75) Inventors: Uttam Ghoshal, Austin, TX (US); Key Kolle, Luling, TX (US); Andrew Carl Miner, Austin, TX (US)

Correspondence Address: ZAGORIN O'BRIEN GRAHAM LLP, 7600B N. CAPITAL OF TEXAS HWY., SUITE 350, AUSTIN, TX, 78731, US

(73) Assignee: NanoCoolers, Inc.

(21) Appl. No.: 11/020,530

(22) Filed: Dec. 23, 2004

Related U.S. Application Data
(60) Provisional application No. 60/610,815, filed on Sep. 17, 2004.
(60) Provisional application No. 60/611,115, filed on Sep. 17, 2004.
(60) Provisional application No. 60/611,651, filed on Sep. 20, 2004.

(51) Int. Cl. F04B 37/02; H02K 44/00

(52) U.S. Cl. 417/50; 417/48

(57) ABSTRACT

A module in accordance with the present invention includes at least one electromagnetic pump and a power supply circuit for the electromagnetic pump. The tight coupling between the pump and its power supply afford more easily driving the pump with a low voltage, high current output of the power supply, and ease of integration in system design.

### CROSS-REFERENCE TO RELATED APPLICATION(S)

The present application claims the benefit of the following U.S. Provisional Applications, each of which is hereby incorporated by reference in its entirety:
U.S. Provisional Application No. 60/610,815 entitled “Magnetofluiddynamic Pumps Technology,” filed on Sep. 17, 2004;
U.S. Provisional Application No. 60/611,115 entitled “Magnetofluiddynamic Pump Configuration Utilizing Conductive Fluid Electrode Channel,” filed on Sep. 17, 2004; and
U.S. Provisional Application No. 60/611,651 entitled “Integrated Electromagnetic Pump and Power Supply Module,” filed on Sep. 20, 2004.

The present application is related to co-pending U.S. application No. xx/xxx,xxx (Attorney Docket 089-0013), entitled “Series-Gated Secondary Loop Power Supply Configuration for Electromagnetic Pump and Integral Combination Thereof,” by Uttam Ghoshal, et al., filed on even date herewith, which application is hereby incorporated by reference in its entirety.

### BACKGROUND

1. Field of the Invention

The present invention relates to electromagnetic pumps, power supply circuits for electromagnetic pumps, and modules including both an electromagnetic pump and a power supply circuit for the electromagnetic pump.

2. Description of the Related Art

Electromagnetic pumps (EMPs) are used for pumping of conductive fluids such as liquid metals. Such pumps, also known by some as magnetofluiddynamic (MFD) pumps or even magnetohydrodynamic (MHD) pumps (even though fluids other than water may actually be employed), find use in systems such as electricity generators, propulsion systems and micro-electromechanical systems. Exemplary applications of MFD pumps include pumping mercury in electrolyte baths in the production of chlorine and caustic soda, the controllable feeding of smelt, the mixing and pumping of molten aluminum, and in magnetofluiddynamic stirrers. MFD pumps are generally more reliable and safe compared to other kinds of pumps, as MFD pumps do not have any moving parts (except, of course, the conductive fluid itself).

The conductive fluid in a MFD pump is pumped by taking advantage of the phenomenon wherein a charge carrier moving in a magnetic field experiences a force perpendicular to both its direction of movement and the magnetic field. The force (F) of many moving charge carriers, i.e., a current (I), moving a distance (L) in a magnetic field having a flux density (B) is expressed as F=B·I·L (assuming a resultant force perpendicular to both the magnetic field and current flow).

The simplest implementation of such a pump may be accomplished by applying a DC bias across a pair of electrodes placed on either side of a flow channel of the pump containing the conductive fluid. A DC voltage is applied across the electrodes to produce an electric current from one electrode, through the conductive fluid, to the other electrode. A pair of permanent magnets may be placed above and below, respectively, the flow channel to create a magnetic field within the flow channel perpendicular to the direction of the current flow across the flow channel. A resulting electromagnetic force acts upon the conductive fluid in a direction perpendicular to the plane defined by the electric current and magnetic field, causing the conductive fluid to flow through the flow channel and thus through the pump. Exemplary MFD pumps are described in U.S. Pat. No. 6,658,861, and in U.S. Pat. No. 6,708,501.

### SUMMARY

To improve the pumping capability of a MFD pump, the net electromagnetic force on the conductive fluid in the pump should be increased. There are several methods by which the net force on the conductive fluid may be increased. For example, the net force may be increased by increasing the magnitude of the current flowing through the conductive fluid, by increasing the magnetic flux density, or by increasing the path length traveled by the charge carriers (the current).

Increasing the current is attractive, so long as overall power dissipation does not rise unacceptably. But since the electrical conductivity of most conductive fluids is very high, the impedance of an MFD pump may be extremely low (e.g., 1 mOhm), and thus the voltage drop across the electrodes within an MFD pump may be extremely low (e.g., 10-30 mV) and the current through the MFD pump may be extremely high (e.g., 10-20 A). Generating such a high current output at such a low voltage presents difficulties in efficient power supply design, and delivering such an output can lead to routing and conductor sizing difficulties, both of which can detract from the advantages otherwise provided by use of an MFD pump.

A module in accordance with the present invention includes an electromagnetic pump and a power supply circuit for the electromagnetic pump. In some embodiments the power supply circuit is responsive to a DC input voltage, while in certain other embodiments the power supply circuit is responsive to an AC input voltage.

In some embodiments, the electromagnetic pump includes a chamber through which a conductive fluid may flow in a fluid flow direction, means for creating within the chamber a magnetic field oriented in a direction generally perpendicular to the fluid flow direction, and a pair of electrodes on opposing sides of the chamber. The electrodes may be oriented such that a current flowing between the electrodes flows in a direction that is perpendicular to both the magnetic field and to the fluid flow direction. The magnetic field direction may have a significant vector component which is perpendicular to the fluid flow direction, and the current flow direction may have a significant vector component which is perpendicular to both the magnetic field direction and the fluid flow direction. The means for creating a magnetic field within the chamber may include an electromagnet coupled to the chamber, or alternatively may include at least one permanent magnet coupled to the chamber.

The power supply circuit may include any of a variety of circuit configurations, including without limitation a flyback circuit configuration, a forward converter circuit configuration, a full bridge circuit coupled to drive a magnetic primary, and a half-bridge circuit coupled to drive a magnetic primary. In some embodiments the power supply circuit includes a secondary winding in series with the electromagnetic pump but with no rectifying device in series therewith, while in other embodiments such a secondary circuit includes a rectifying device. The electromagnetic pump may include a pair of permanent magnets respectively coupled to opposite sides of the chamber to create the magnetic field within the chamber.

In certain embodiments the module includes a second electromagnetic pump coupled to the power supply circuit. The power supply circuit may include a wound toroid with a primary winding and two secondary windings, each respective secondary winding coupled in series to a respective switch device controlled to only conduct current therein during a respective half-cycle, and further respectively coupled to a respective one of the electromagnetic pumps. The secondary winding may include no more than 2 turns, and for other embodiments may include no more than 1 turn. In other embodiments each respective secondary winding includes a respective conductor passing through but not looped around the toroid, and then coupled in series to a respective one of two switch devices and to a respective one of the two electromagnetic pump.

The foregoing is a summary and thus contains, by necessity, simplifications, generalizations and omissions of detail. Consequently, those skilled in the art will appreciate that the foregoing summary is illustrative only and that it is not intended to be in any way limiting of the invention. Other aspects, inventive features, and advantages of the present invention, as defined solely by the claims, may be apparent from the detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram of a module in accordance with certain embodiments of the invention.

FIG. 2 is a block diagram of a module in accordance with certain embodiments of the invention.

FIG. 3A is a schematic diagram depicting a power supply circuit useful for certain embodiments of the invention.

FIG. 3B is a diagram depicting the current flow within a secondary loop circuit relative to current flowing between such secondary loop circuits.

FIG. 4 is a three-dimensional diagram of a fluidic cooling system incorporating an electromagnetic pump module in accordance with certain embodiments of the present invention.

FIG. 5 is a side elevation view of an exemplary electromagnetic pump module shown in FIG. 4.

FIG. 6 is a front elevation view of an exemplary electromagnetic pump module shown in FIG. 4.

FIG. 7 is a front view of a first printed wiring board useful for certain embodiments of the invention.

FIG. 8 is a front view of a second printed wiring board useful for certain embodiments of the invention.

FIG. 9 is a plan view of an integrated circuit layout useful for implementing a low resistance switching transistor which is useful for certain embodiments of the invention.

FIG. 10 is a schematic diagram depicting a power supply circuit useful for certain embodiments of the invention.

FIG. 11 is a schematic diagram depicting another power supply circuit useful for certain embodiments of the invention.

FIG. 12 is a schematic diagram depicting yet another power supply circuit useful for certain embodiments of the invention.

FIG. 13 is a schematic diagram depicting still another power supply circuit useful for certain embodiments of the invention.

FIG. 14 is a cross-sectional diagram representing an electromagnetic pump utilizing an electromagnet that is useful for certain embodiments of the invention.

FIG. 15 is a waveform diagram illustrating operation of the electromagnetic pump shown in FIG. 14.

FIG. 16 is a schematic diagram depicting still another power supply circuit useful for certain embodiments of the invention.

FIG. 17 is a table comparing the relative merit of certain embodiments of the invention against a group of possible criteria.

FIG. 18 is a cross-section diagram of an exemplary magnetofluiddynamic pump in which the electrodes on either side of the chamber, as well as the entire circuit path for the electrical current flowing through the pump chamber, are formed of a conductive fluid channel.

FIG. 19 is an isometric diagram of an exemplary magnetofluiddynamic pump, such as the embodiment shown in FIG. 17, in which the electrodes on either side of the chamber and the entire secondary loop circuit are formed of a conductive fluid channel.

FIG. 20 depicts a generalized block diagram of a MFD pump having a conductive fluid electrode.

The use of the same reference symbols in different drawings indicates similar or identical items.

### DETAILED DESCRIPTION

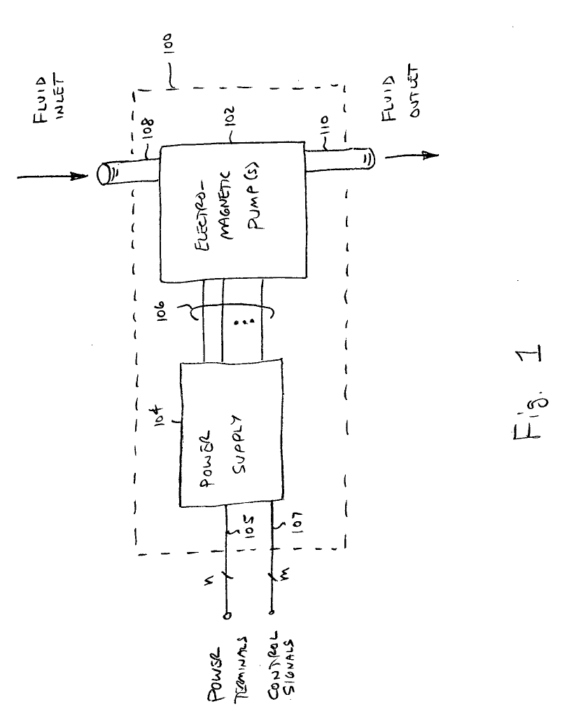

Referring now to FIG. 1, a module 100 in accordance with some embodiments of the present invention includes at least one electromagnetic pump 102 and a power supply circuit 104 for the electromagnetic pump 102. The electromagnetic pump 102 includes a chamber through which a conductive fluid may flow (not shown), a fluid inlet 108, and a fluid outlet 110. A magnetic field is created within the chamber, preferably oriented in a direction generally perpendicular to the fluid flow direction. A pair of electrodes is disposed on opposing sides of the chamber and oriented such that a current flowing between the electrodes flows in a direction that is generally perpendicular to both the magnetic field and to the fluid flow direction. In certain embodiments, the magnetic field direction has a significant vector component which is perpendicular to the fluid flow direction, and the current flow direction has a significant vector component which is perpendicular to both the magnetic field direction and the fluid flow direction. Additional details of useful electromagnetic pumps are described in co-pending U.S. application Ser. No. 10/443,190 entitled “Direct Current Magnetohydrodynamic Pump Configurations” by Andrew Carl Miner, et al., filed May 22, 2003, the disclosure of which is hereby incorporated by reference in its entirety.

The power supply circuit 104 receives a source of power conveyed on power terminals 105, and may receive one or more control signals conveyed on input terminals 107. Such control signals may include signals for modulating the amount of fluid flow, for turning on and off the fluid flow, and/or other useful capabilities. The source of power may be an AC voltage such as, for example, a 120 VAC line voltage or a lower magnitude AC voltage, or may be a DC voltage such as, for example, a 4-8 VDC voltage, or even a 4-12 VDC voltage. Such a DC voltage may be any convenient voltage in a system within which the module 100 may reside (e.g., 5 VDC; 12 VDC), or may be specifically generated for use with the power supply circuit 104. The power supply circuit 104 generates one or more output signals conveyed on bus 106 coupled to the electromagnetic pump 102. Such output signals may be high-current, very low voltage outputs, as described below.

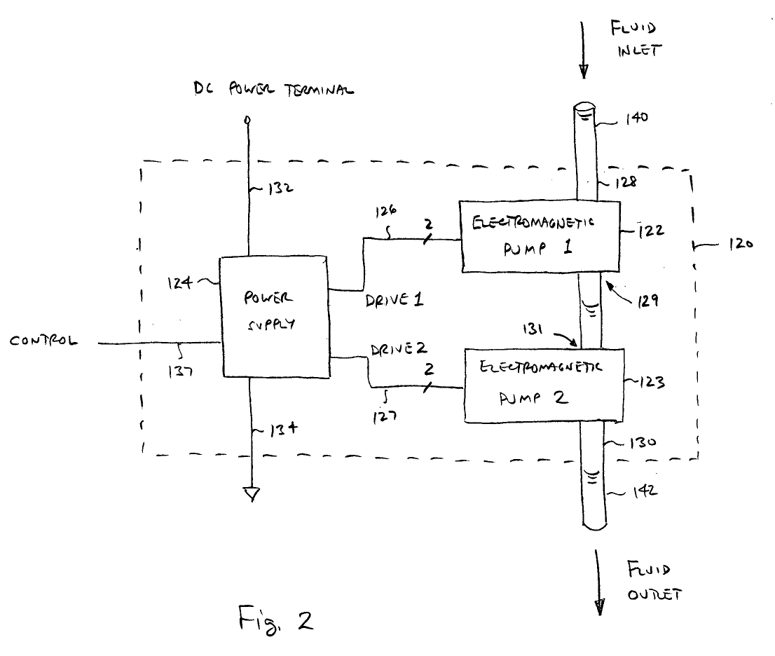

Referring now to FIG. 2, a module 120 in accordance with some embodiments of the present invention includes two electromagnetic pumps 122, 123 and a power supply circuit 124 for the electromagnetic pumps 122, 123. The electromagnetic pump 122 includes, as before, a chamber through which a conductive fluid may flow (not shown), a fluid inlet 128, and a fluid outlet 129. Similarly, electromagnetic pump 123 includes a chamber through which the conductive fluid may flow (not shown), a fluid inlet 131, and a fluid outlet 130. The configuration of each of the two electromagnetic pumps 122, 123 may be similar or identical to that described above.

The fluid outlet 129 of electromagnetic pump 122 is connected to the fluid input 131 of electromagnetic pump 123 to create a fluid path which passes from a module fluid input 140, through both electromagnetic pumps 122, 123, and out through a module fluid output 142. A power supply circuit 124 receives a source of power conveyed on power terminals 132, 134 which are here shown, for example, as DC power terminal 132 and ground reference terminal 134. The power supply circuit 124 may optionally receive one or more control signals conveyed on control input terminals 137. The source of DC power may be a voltage such as, for example, a 4-8 VDC voltage. In the embodiment depicted, the power supply circuit 124 generates a first output signal DRIVE1 conveyed by way of a pair of conductors 126 to electromagnetic pump 122, and generates a second output signal DRIVE2 conveyed by way of a pair of conductors 127 to electromagnetic pump 123.

The DRIVE1 and DRIVE2 output signals are each generated to provide a high current through the respective electromagnetic pump with a very low voltage present across the respective electromagnetic pump. In certain embodiments, these two output signals 126, 127 may be continuous (i.e., DC) currents or pulsed (i.e., AC) currents, and such pulsed currents may be in-phase, overlapping in phase, or out-of-phase signals.

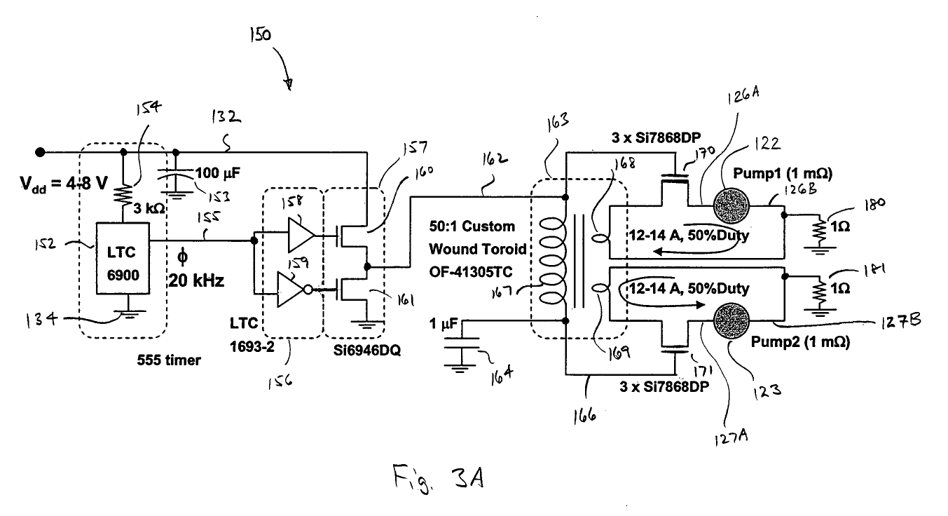

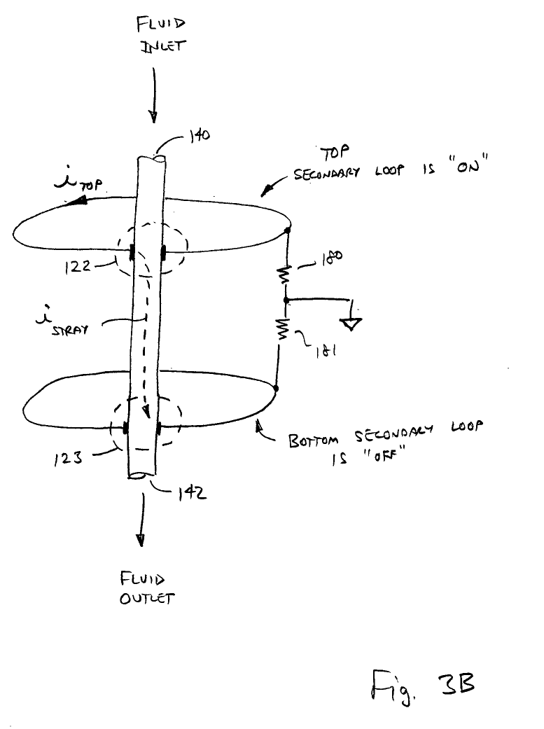

An exemplary power supply circuit 124 is depicted as power supply circuit 150 in FIG. 3A, which is shown connected to electromagnetic pumps 122, 123. Generally, the power supply circuit 150 functions as a switching DC-DC converter type of circuit, but having an extremely high output current through the electromagnetic pumps and an extremely low output voltage across the electromagnetic pumps.

An oscillating signal having a frequency of, for example, 20 kHz is generated on node 162, which is coupled to one end of a primary winding 167 of transformer 163. The other end (node 166) of the primary winding 167 is AC-coupled to ground by capacitor 164, which allows node 166 to also oscillate at the same excitation frequency as node 162, and with a similar amplitude (but with a different phase) as node 162. During a first one of the two half-cycles of the oscillation period, switch device 170 is turned on by a sufficiently high voltage on node 162 (i.e., above the threshold voltage of device 170) and causes current to flow in the “upper” loop formed by secondary winding 168, switch device 170, and electromagnetic pump 122. During the second half-cycle, the voltage on node 162 is driven low, the switch device 170 is turned off, and no current flows through secondary winding 168. Resistor 180 functions to provide a ground reference for the secondary circuit. Relative to the very low impedance of the secondary loop itself (i.e., device 170, wire 126A, 126B, electromagnetic pump 122, and secondary coil 168), the exemplary 1 ohm value of this resistor 180 is actually quite large, and substantially most of the current flows within the secondary loop circuit rather than through the resistor 180. For example, the device 170 may have a nominal impedance of approximately 1 milliOhm, and may be implemented as a single device (as drawn in the figure) or as multiple parallel devices to help achieve the desired low impedance. For example, three parallel-connected Si7868DP devices from Vishay Siliconix may be used to implement device 170. The impedance of the electromagnetic pump 122 may have an approximate value of only 1 milliOhm.

During this second half-cycle, node 166 is high enough in voltage to turn on switch device 171, and causes current to flow in the “lower” loop formed by secondary winding 169, switch device 171, and electromagnetic pump 123. Substantially all the flux created in the transformer 163 by the primary winding 167 during the second half-cycle is coupled to the secondary winding 169 because switch device 170 is off and ensures that no current can flow through the other secondary winding 168. Resistor 181 functions to provide a ground reference for the secondary circuit. Relative to the very low impedance of the secondary loop itself (i.e., device 171, electromagnetic pump 123, secondary coil 169, and the interconnecting wiring), the exemplary 1 ohm value of this resistor 181 is actually quite large, and substantially most of the current flows within the secondary loop circuit rather than through the resistor 181.

The oscillating signal conveyed on node 162 may be adequately generated in many different ways, including using discrete transistors, LC oscillators, RC oscillators, integrated circuits providing oscillator functions, integrated driver or buffer circuits, single integrated circuits providing both oscillator and driver functions, and others. One such way is shown as part of the power supply circuit 150 depicted in FIG. 3A. An integrated circuit 152 functions as an oscillator, providing a square-wave output signal on output node 155 having, for example, a frequency of 20 kHz. The integrated circuit 152 is coupled to the DC power terminal 132 (through resistor 154) and further coupled to the ground reference power terminal 134 (i.e., “ground”). A bypass capacitor 153 provides filtering for the voltage operably conveyed on the DC power terminal 132. The integrated circuit 152 may be implemented using, for example, the LTC6900 available from Linear Technology, Inc.

The square-wave output signal 155 is coupled to a pair 156 of buffers 158, 159 to generate complementary signals, which are then coupled to drive a pair of N-channel (NMOS) transistors (arranged here in a totem-pole configuration) to provide a higher drive capability output signal 162 for driving the winding 167, as described above. As depicted in the figure, the pair 156 of buffers may be implemented within a single integrated circuit, such as the LTC1693-2 available from Linear Technology, Inc. The pair 157 of NMOS driver transistors 160, 161 may be implemented, for example, using the Si6946DQ available from Vishay Siliconix. Many other circuit configurations for generating such a buffered signal 162 may alternatively be used. For example, bipolar transistors may be employed as the driver pair 157, either as a complementary pair (i.e., NPN and PNP) or as a pair of like polarity transistors (e.g., both NPN). One of ordinary skill will appreciate many equivalent circuits and structures for generating a low frequency oscillating signal with high drive capability.

Referring now to FIG. 3B, the two pumps 122 and 123 are shown in a three-dimensional schematic diagram to help illustrate the role of resistors 180 and 181. Assume the top secondary loop circuit is “on” and the bottom secondary loop circuit is off. If current traversing the top secondary loop conducts along the fluid path to the bottom loop, rather than traversing around just the top loop, the pumping efficiency of the pump 122 will be diminished. The resistors 180, 181, although sized in this exemplary embodiment as 1 ohm resistors, are actually quite large relative to the desired impedance of each secondary loop, and so the stray current, I_{STRAY}, is kept small. Yet the resistors 180, 181 are still low enough in impedance to effectively provide a voltage reference (i.e., “ground” reference) for the secondary loop circuits of the power supply circuit transformer.

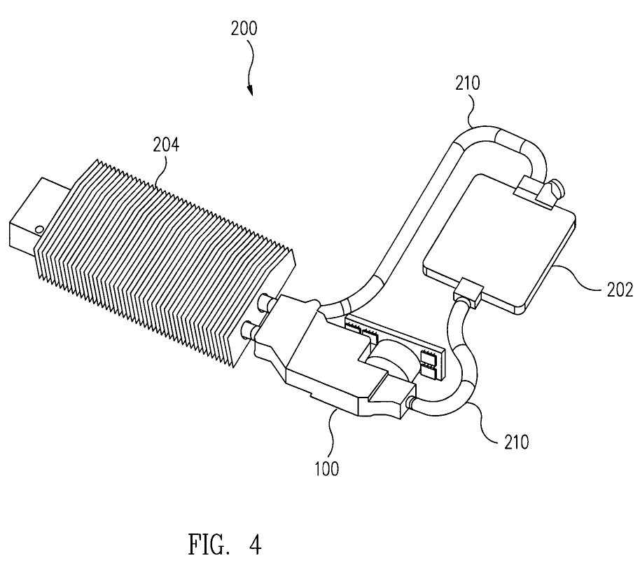

A system incorporating the exemplary module 100 thus far described is depicted in FIG. 4, such as for dissipating heat from a high power density device. The system includes a source exchanger 202 (e.g., a “thermal collector”), the pump/power supply module 100, and a thermal dissipater 204 coupled in series by a conductive fluid path 210, such as a conduit, pipe, tubing, or other structure. In some systems, a second source exchanger (not shown) may be coupled in fluidic series with the source exchanger 202 by a continuous conductive fluid path 210.

In certain particularly desirable embodiments, the source exchanger 202 may be implemented to draw heat away from an integrated circuit or other packaged electronic device, such as within a notebook computer or other electronic enclosure, and transfer the heat to the conductive fluid flowing within the conductive fluid path 210 (propelled by the electromagnetic pump within the module 100). The thermal dissipater 204 may be implemented to dissipate such heat conveyed by the conductive fluid to a larger heat sink, to ambient air, or to some other thermal sink. Other configurations may be configured so that heat flow is reversed, thereby heating a device rather than cooling it.

Multiple electromagnetic pumps may be provided in series configuration (e.g., such as in the dual pump module 100 as shown, or by two single pump modules, as described below) where fluid power supplied by one pump is not sufficient to circulate the conductive fluid in the form of a closed loop. This may be the case when the thermal dissipater 204 is placed at a relatively large distance away from the source exchanger 202. Two electromagnetic pumps in fluidic series may also be useful where there is sudden loss in the pressure head, such as in a configuration where the fluid pipes 210 take sharp turns (like in case of laptop joints) where a significant drop in the pressure may be observed.

The system 200 includes a solid-fluid heat exchanger (e.g., the source exchanger 202) placed adjacent to a high power density device to be cooled. The solid-fluid heat exchanger 202 is filled, in certain exemplary embodiments, with a liquid metal or other conductive fluid that absorbs the heat from the high power density device. The conductive fluid path 210 passes through solid-fluid heat exchanger 201 and circulates the conductive fluid through the heat dissipater 204, which releases the heat to the atmosphere, and circulates the cooled conductive fluid back to the source exchanger 202. The module 100 provides the fluid power for circulating the conductive fluid in the form of a closed loop. In this manner, the system 200 provides for the transport and dissipation of heat at a predefined distance away from a high power density device coupled to the source exchanger 202. This distance is determined based on the form factor (the configuration and physical arrangement of the various components in and around the high power density device). Thus system 200 provides for heat dissipation in the cases where dissipating heat in the proximity of the high power density device 202 is not desirable. For example, in a computer, the heat dissipated by components such as the microprocessor or the power unit may be in proximity of components like memory, and this heat may lead to permanent loss of data from the memory or shortened component lifetimes of various devices within the computer. Thus it is desirable that the heat generated by the microprocessor/power unit is dissipated at a location some distance away from components that may get damaged.

The thermal dissipater 204 may be constructed of a low thermal resistance material (e.g., copper and aluminum) and has a large surface area for effectively dissipating heat to the atmosphere. The thermal dissipater 204 may dissipate heat by natural convection or by forced convection with the use of a fan. A finned structure (as shown in the figure) is sometimes advantageously used as a heat sink. In some embodiments, the conductive fluid may also circulate through its fins. It should be apparent to one of ordinary skill in the art that other heat sink structures may alternatively be used.

Referring now to FIG. 5, a side view is depicted of an exemplary embodiment 220 of a module in accordance with the present invention. This particular module includes two electromagnetic pumps 226, 228 which are connected so that fluid flowing into a fluid inlet 222 flows sequentially through electromagnetic pump 226, electromagnetic pump 228, and out of the module from fluid outlet 224. Each of the two electromagnetic pumps includes a pair of permanent magnets housed on either side of the internal pump chamber. The electromagnetic pump 228 includes a pair of housings 230, 232 which hold the pair of permanent magnets for electromagnetic pump 228.

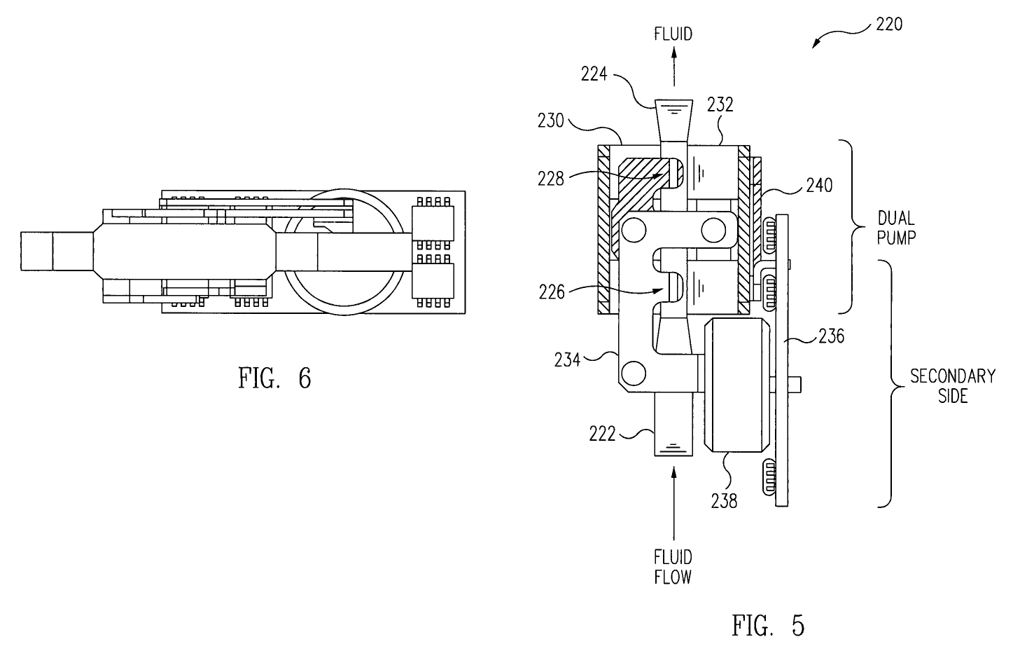

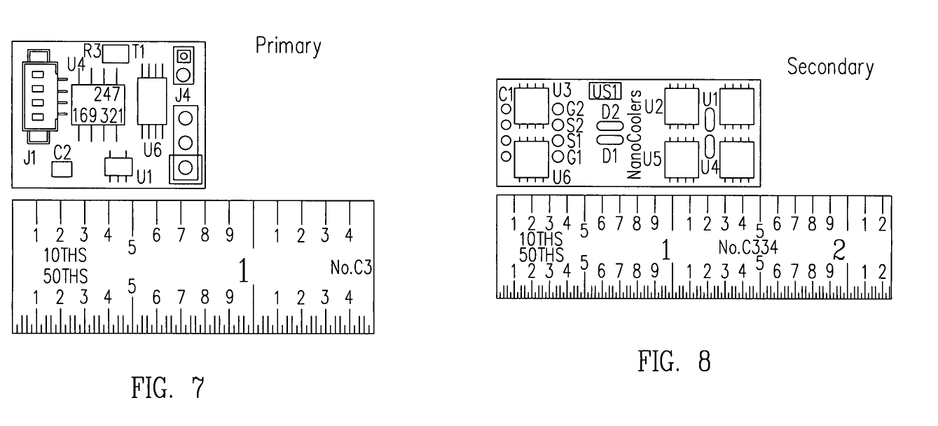

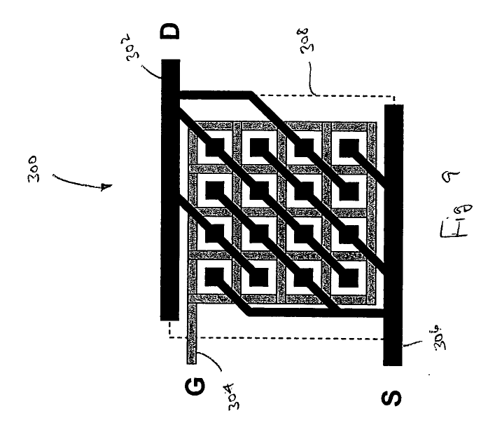

In some embodiments, a printed wiring board 236 includes portions of the power supply circuit for the module 220, and particularly includes circuitry coupled to the secondary windings of the transformer core 238. The primary winding and additional circuitry for excitation of the primary winding is not shown in FIG. 5. A fluid inlet 222 is provided for receiving conductive fluid, which is pumped by the two series pumps and conveyed out a fluid outlet 224. Permanent magnets 230, 232 are illustrated for the second of the two series pumps along with one of its electrodes 228. An electrode for the first pump is labeled as 226. Most conductors forming each secondary circuit are formed by bus bar structures, such as 234 and 240 to reduce electrical resistance as well for structural stability. The switch devices for the secondary loop circuits are disposed on printed wiring board 236. Another side view of the exemplary module 220 is shown in FIG. 6.

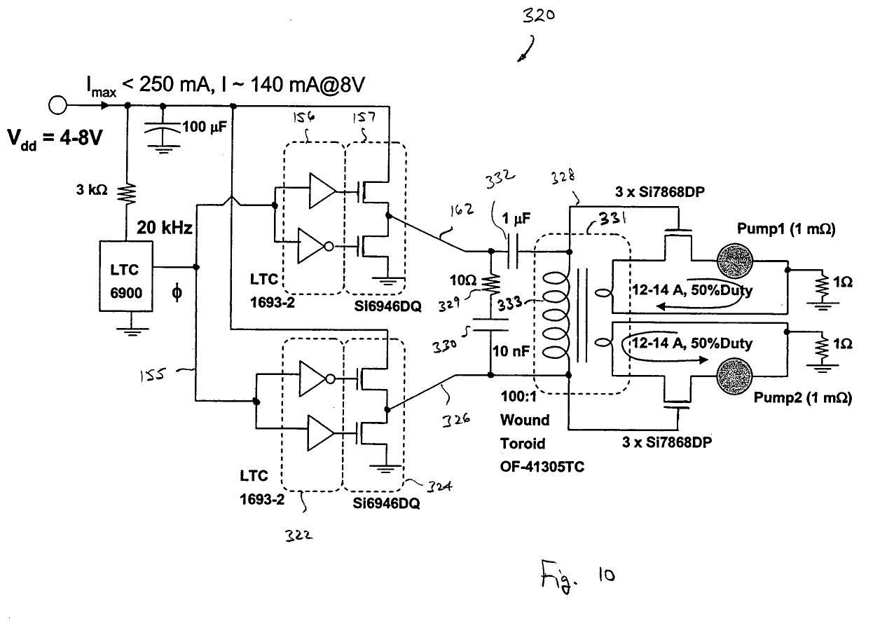

In embodiments of the power supply circuit which utilize a switch device in the secondary circuit, it is advantageous to limit the voltage drop across such a switch device in order to achieve a high current through the electromagnetic pump having a very low voltage across the pump. Referring now to FIG. 9, a desirable layout 300 is shown for a switch device useful for the power supply circuit. The layout 300 corresponds to an insulated gate field effect transistor (i.e., IGFET), which frequently are also called MOSFETS (literally “Metal-Oxide-Semiconductor Field Effect Transistor”) or even just FET. Such a FET is typically a three terminal device having drain, gate, and source terminals, although other variations are known. In FIG. 9, a three-terminal FET is shown having a drain terminal 302, a gate terminal 304, and a source terminal 306. If such a FET is an N-channel FET (i.e., as depicted by switch device 170 in FIG. 3A), boundary 308 corresponds to an active area region formed within a p-type substrate or well. The gate terminal 304 is implemented as a patterned polysilicon layer having multiple horizontal and multiple vertical stripes, thereby forming closed regions of active area surrounded by gate polysilicon. Alternating ones of these closed regions are connected to the drain terminal 302 and to the source terminal 306. This provides a transistor with a large effective “width” for a given amount of area consumed on the integrated circuit, and also provides a very low resistance in both the source and drain regions of the FET.

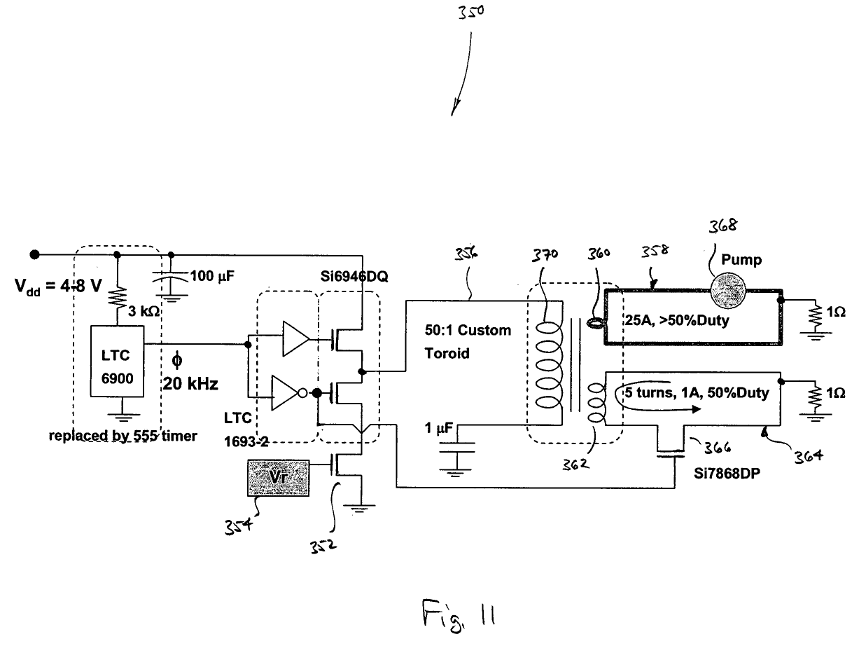

Another power supply circuit which includes a switched secondary circuit (i.e., a switch device interrupting at times current flow in a secondary loop) and which is useful for the present invention, is shown in FIG. 10. The power supply circuit 320 has many structural similarities to the power supply circuit 150 shown in FIG. 3A, but this power supply circuit 320 may be viewed as a “full-bridge” circuit whereas the power supply circuit 150 may be viewed as a “single-bridge” or “half-bridge” circuit. The power supply circuit 320 includes a second high-drive capability driver circuit for generating a second square-wave signal 326 which is generally out of phase with the first square-wave signal 162. A second pair of buffers 322 is responsive to the signal 155, but are reversed in polarity such that the second pair 324 of driver transistors generates a signal on node 326 which is complementary to that conveyed on node 162.

By having a pair of high drive outputs 162, 326, both ends of the primary winding 167 may be driven. One end of the primary winding 167 (node 328) is driven through a core balancing capacitor 332 by node 162, and the other end (node 326) is driven directly. The core balancing capacitor 332 ensures that misbalances between the signals 162, 326 do not result in a DC signal across the primary coil 167. The series combination of capacitor 330 and resistor 329 functions as a “snubber” circuit to reduce instantaneous voltage spikes which might otherwise result across the primary coil 167.

Relative to the half-bridge circuit depicted in FIG. 3A and described above, the turns ratio of the transformer 331 (i.e., the ratio of turns between the primary coil 333 and each secondary coil) is depicted as being 100:1. In the half-bridge circuit depicted in FIG. 3A and described above, the turns ratio of the transformer 163 is depicted as being 50:1. Because the complementary signals 162, 326 are each a ground-to-V_{DD} signal and are out-of-phase with each other, a total bias of 2·V_{DD} is impressed across the primary coil 333 (compared with only a total bias of V_{DD} across primary coil 167), and the resultant voltage induced in the respective secondary coils for both circuits is substantially similar.

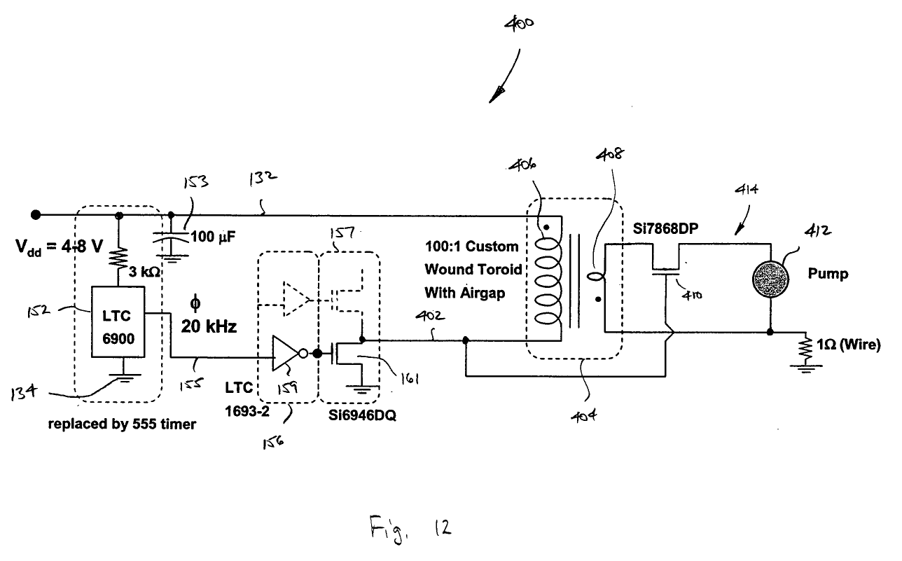

Yet another power supply circuit useful for the present invention is shown in FIG. 11. Here the power supply circuit 350 again has many structural similarities to the power supply circuit 150 shown in FIG. 3A, but this power supply circuit 350, which is configured for driving a single electromagnetic pump, omits the switch device in the secondary circuit coupled to the electromagnetic pump, and utilizes different turns ratios for the two secondary windings. This power supply circuit 350, like that shown in FIG. 3A, is a single-bridge circuit which actively drives only one end of the primary winding, but also includes a current limiting transistor 352 in the grounding path for the driver for output node 356. By adjusting the reference voltage V_{R} (labeled 354) coupled to the gate of transistor 352, the current through the primary winding may be controlled.

In operation, during one of the half-cycles current flows through secondary circuit 358 (i.e., through the secondary winding 360 and the electromagnetic pump 368), but no current flows though the other secondary circuit 364 because the switch device 366 is turned off. In this way all the flux generated by the primary winding is coupled to just one of the two secondary windings, in this case secondary winding 360. During the other half-cycle, a current flows through secondary circuit 358 in the reverse direction than before, but in this half-cycle device 366 is turned on and current also flows through secondary circuit 364. If, for example, the secondary winding 360 has one turn, the secondary winding 362 has five turns, and the primary winding 370 has fifty turns, then in the case when both secondary circuits are conducting, flux in the transformer core is coupled into all six turns of the two secondary windings, and the total induced current is significantly lower than if coupled into just one secondary winding having just one turn.

For the secondary circuit which includes the electromagnetic pump, during one half-cycle a high magnitude current (e.g., 25 A) flows in one direction, but during the other half-cycle, a much lower current (e.g., 5 A) flows in the opposite direction. Although the conductive fluid within the electromagnetic pump is “pushed” in one direction during the one half-cycle, and pushed in the opposite direction during the other half-cycle, the relative magnitude of these two forces are different (because the current through the electromagnetic pump is different each half-cycle), and the net effect of the electromagnetic pump is to force the conductive fluid in only one direction. Colloquially, this may be viewed as a “5 steps forward, 1 step back” manner of operation. The flow of conductive fluid through the pump(s) may be further rectified by using Tesla valves, which are constructed to preferentially favor fluid flow in one direction through the valve over the other direction. Advantageously, this power supply circuit 350 is relatively simple, being a single bridge circuit and, although still utilizes two secondary windings, is configured to relatively efficiently drive only one electromagnetic pump.

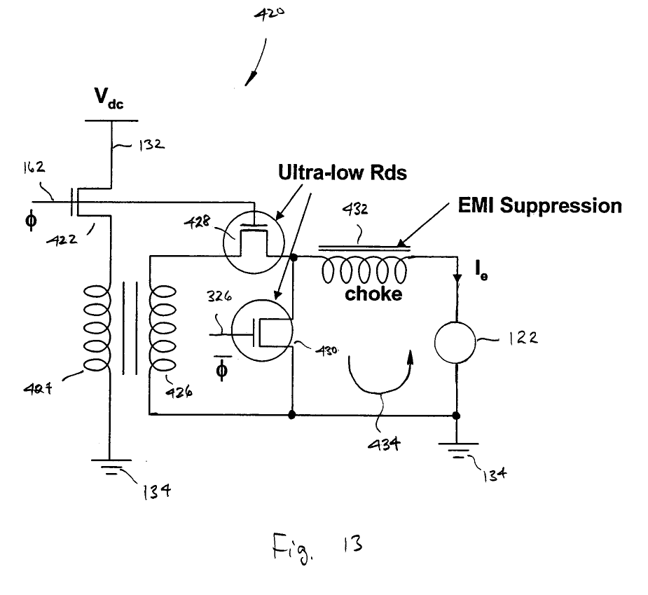

Another power supply configuration well suited for use with a single electromagnetic pump is shown in FIG. 12. Here, the power supply circuit 400 is arranged in a flyback configuration. As described in earlier embodiments, node 155 conveys a low-frequency square-wave signal generated by, for example, integrated circuit oscillator 152. This signal is buffered by buffer 159 and driver FET 161 to generate a high-drive capability signal on node 402 having the same frequency as node 155. In this embodiment, a full totem pole driver is not used because the flyback transformer 404 may be adequately driven by just a “pull-down” only driver stage (i.e., buffer 159 and FET 161). During one-half of the cycle, node 402 is essentially grounded by FET 161, thus allowing current to build up through primary winding 406, thus storing magnetic energy in the transformer. During the other half-cycle, the FET 161 shuts off and the voltage of node 402 shoots above the V_{DD} voltage conveyed on power supply node 132, causing the secondary circuit switch device 410 to turn on, and thus causing current to flow through the secondary winding 408 and through the electromagnetic pump 412. The magnetic energy stored during the first half-cycle is discharged during the second half-cycle.

Referring now to FIG. 13, yet another configuration is shown of a power supply circuit useful for the present invention. Here, a forward converter configuration 420 is depicted. Complementary signals 162 and 326 (e.g., as might be generated in the manner shown in FIG. 10, or by some other suitable technique) conveyed to a group of switches 162, 428, and 430 to pump current into a choke 432 during one half-cycle (e.g., when switch 428 is turned on), and then to provide a path for such choke current to recirculate (labeled as 434) during the other half-cycle (e.g., when switch 430 is turned on), thereby providing a continuous load current, in this case through the electromagnetic pump 122. A transformer includes primary winding 424, which is energized when switch transistor 422 is turned on by signal 162, and further includes secondary winding 426.

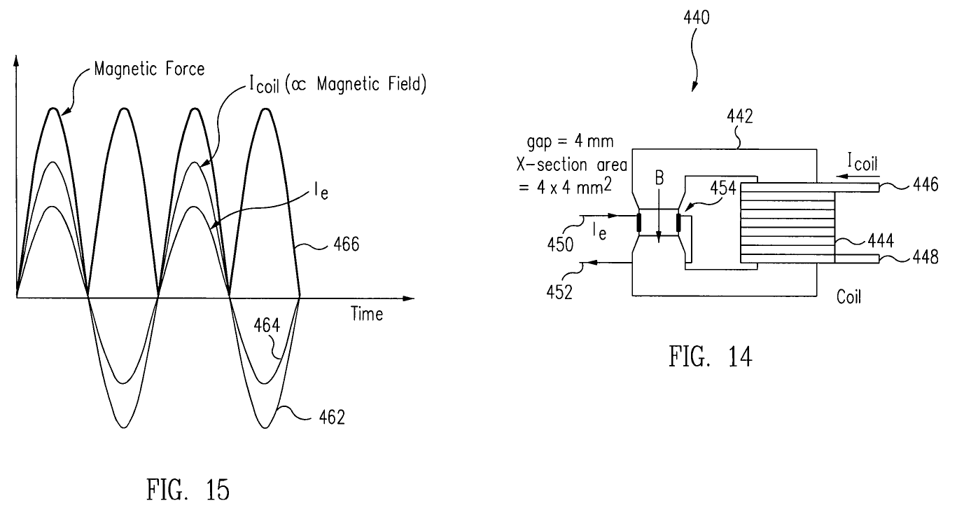

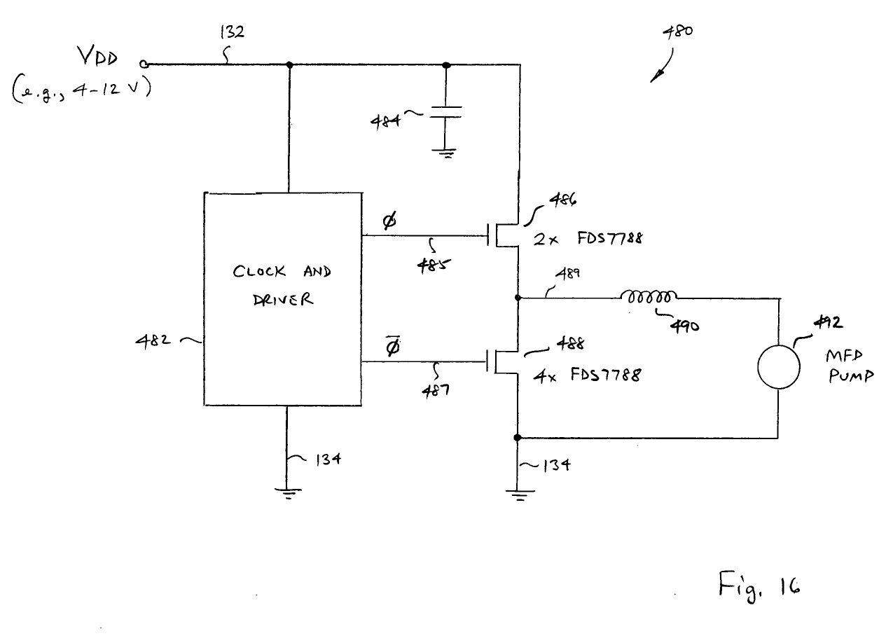

The present invention need not incorporate power supply circuits which are or are similar to DC-DC converter circuits, nor which necessarily incorporate permanent magnets in the electromagnetic pump portions. For example, an electromagnetic pump 440 utilizing a first AC signal to excite an electromagnet, and utilizing a second AC signal to generate current flow through the conductive fluid within the pump chamber, is depicted in FIG. 14. An AC magnetic field is created in the pump chamber 454 by magnetic core 442 and coil 444, when an AC signal is provided across terminals 446 and 448. The polarity of the magnetic field created within the chamber 454 reverses each half-cycle of the exciting signal coupled to the coil 444. This alone might suggest that the conductive fluid is forced in one direction (i.e., into the page, as drawn) during one half-cycle, but forced in the other direction (i.e., out of the page) during the other half-cycle, resulting in no net movement of the fluid. However, if the electrical current flowing across the pump chamber 454 and through the conductive fluid is also an AC signal, in accordance with the right-hand rule, the net force applied to the conductive fluid is in the same direction during both half-cycles. FIG. 15 depicts exemplary waveforms of the coil current, I_{COIL}, labeled as 462, and of the AC fluid current, Iₑ, labeled as 464. The resultant force imparted to the conductive fluid is labeled as 466, is a pulsed signal having the shape of a half-sinusoid.

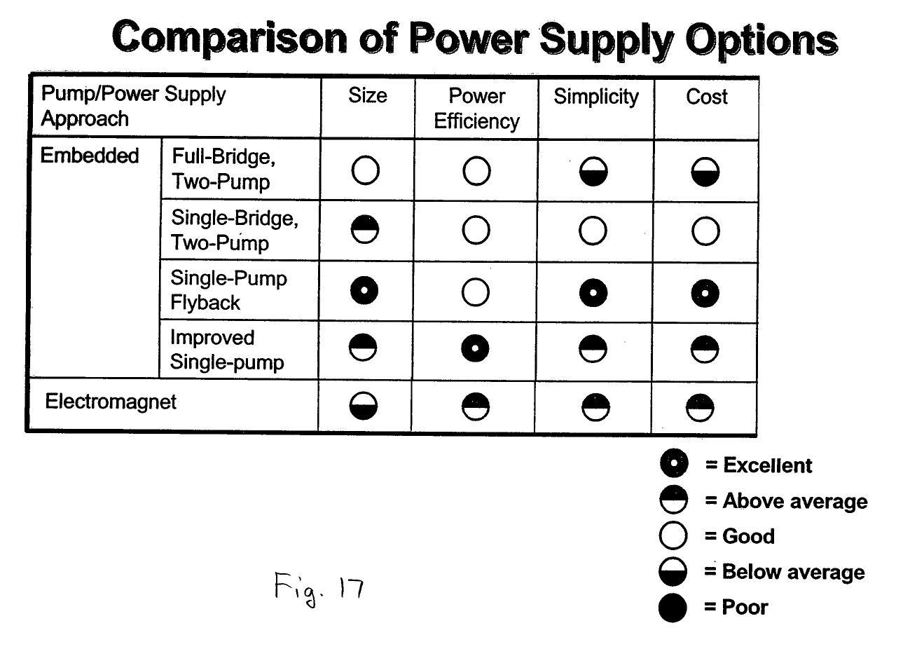

Another power supply configuration well suited for use with a single electromagnetic (i.e., MFD) pump is shown in FIG. 16. Here, an exemplary “buck” converter configuration 480 is depicted. A clock and driver circuit 482 generates two complementary signals on respective nodes 485 and 487. Such a clock and driver circuit 482 may be implemented in any of a wide variety of configurations, as described above, and may be configured to generate its complementary output signals 485, 487 having a frequency of around 20 KHz. Such a frequency is a desirable frequency as it is higher than the usual audio band (and thus does not readily generate audible noise) and yet is well below other frequencies of interest within the system, and thus it not as likely to interfere with the remainder of the system. The complementary signals 485, 487 are conveyed respectively to driver devices 486, 488 to pump current into a choke 490 and through the MFD pump 492 during one half-cycle when driver device 486 is turned on, and then to provide a path for such choke current to recirculate during the other half-cycle when driver device 488 is turned on, thereby providing a non-uniform unipolar load current through the electromagnetic pump 492. This unipolar current varies in magnitude, slowly rising in magnitude when device 486 is on, and slowly decreasing when device 488 is on. This circuit 480 is particularly simple and may be inexpensively implemented. However, the current drawn from the VDD supply coupled to node 132 is relatively high in average magnitude and is also non-uniform since the operation of the driver devices 486, 488 contributes to current spikes in the operating current. The bypass capacitor 484 is included and sized appropriately to help reduce power supply noise as a result of these current spikes.

Referring now to FIG. 17, a chart is shown which compares the relative size, power efficiency, simplicity, and cost of various ones of the power supply circuits described above. The “optimal” choice, of course, may depend upon the relative importance of the various factors listed, and possibly other factors, for a given application. For example, if cost is the paramount concern, then a Single Pump Flyback configuration (e.g., an exemplary embodiment of which is depicted in FIG. 12) may be more desirable. Alternatively, if power efficiency is paramount, then an Improved Single Pump configuration (e.g., an exemplary embodiment of which is depicted in FIG. 11) may be more desirable.

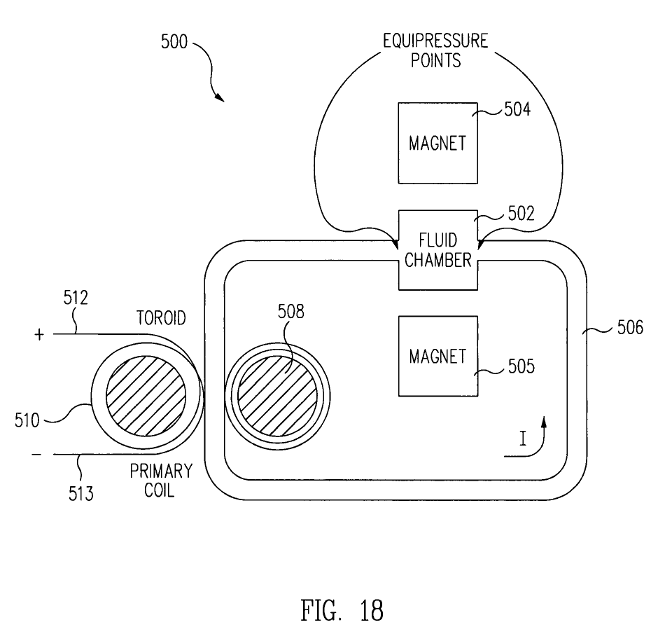

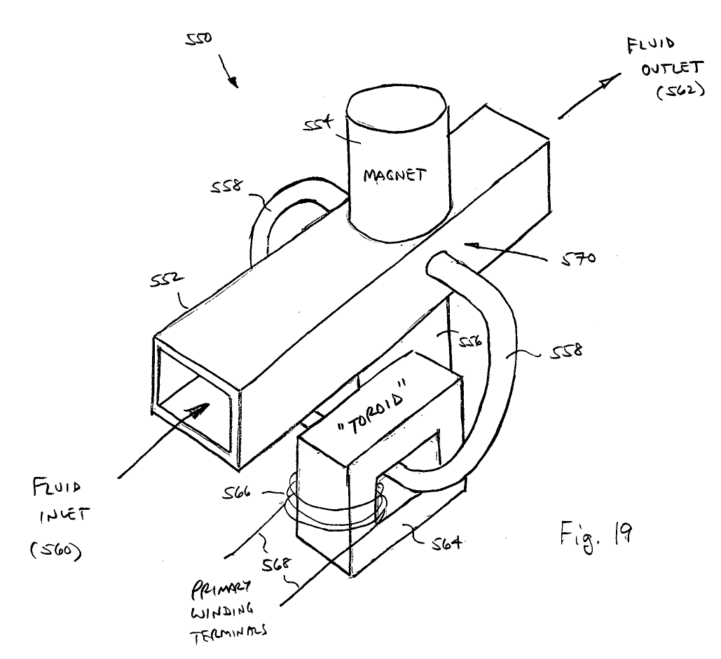

Referring now to FIG. 18, a MFD pump 500 is depicted in which the electrodes on either side of the chamber, as well as the entire circuit path for the electrical current flowing through the pump chamber, are formed of a conductive fluid channel. In the figure, the pump is depicted in a cross-sectional view, showing a fluid chamber 502 with a pair of permanent magnets 504, 505 respectively above and below the chamber 502. (The conductive fluid flow direction would be either into or out of the page.) A conductive fluid channel 506 forms both electrodes on either side wall of the chamber 506, and also forms the circuit path carrying the current which flows through the chamber 506. While the fluid which fills the conductive fluid channel 506 may be (as is shown here) the same fluid which flows through the fluid chamber 502 of the pump (which flows either into or out of the page), there is no fluid flow through the conductive fluid channel 506 (i.e., the conductive fluid “electrode”) because the openings on either side of the fluid chamber 502 into the conductive fluid channel 506 are preferably symmetrically located within the chamber and are thus equipressure points. The conductive fluid is present within the conductive fluid channel 506 to support the flow of electrical current, particularly from one side of the fluid chamber 502 to the other to propel the conductive fluid in a direction normal to the page.

In the exemplary structure shown, the conductive fluid channel 506 is routed through a magnetic toroid 508, thus forming one “turn” of a secondary winding. A primary winding 510 is also wound around the toroid 508 (here shown, for clarity, as having many “turns”). In exemplary embodiments, the turns ratio for such a transformer formed by toroid 508, primary winding 510, and secondary winding formed by conductive fluid channel 506 may advantageously be 50:1, or 100:1, or some other useful value, to achieve a very high current output through the conductive fluid channel 506 and through the pump chamber 502. In other embodiments, the conductive fluid channel 506 may be formed to include an additional turn around the toroid 508, giving rise to a secondary winding having 2 turns, or may include additional turns.

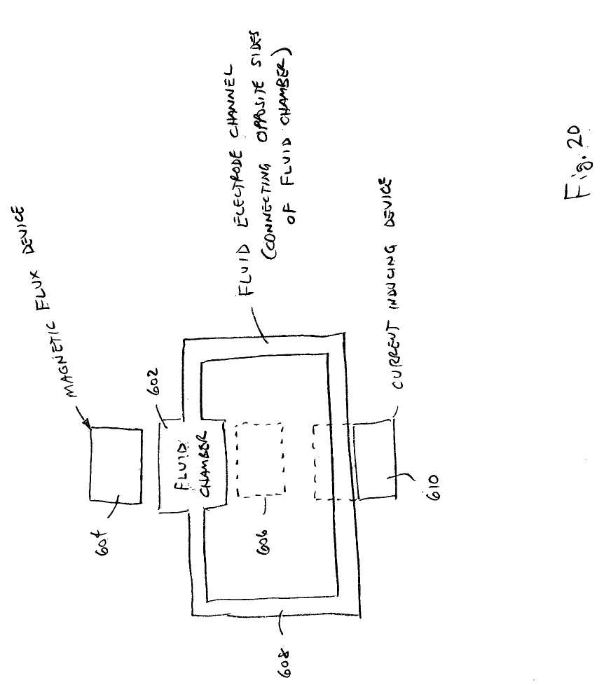

Referring now to FIG. 19, a MFD pump 550 is depicted in which the electrodes on either side of the chamber and the entire secondary loop circuit are formed of a conductive fluid channel. In the figure, the pump 550 is depicted in a three-dimensional view, showing a fluid inlet 560 and a fluid outlet 562. A pump chamber (not shown explicitly) is the region within the fluid path between the fluid inlet 560 and fluid outlet 562 which is located between a pair of permanent magnets 554, 556 respectively above and below the pump chamber. Exemplary magnets 554, 556 may be small NdFeB permanent magnets placed approximately 2.4 mm apart. A conductive fluid channel 558 forms both electrodes on either side wall of the chamber (one of which is labeled 570), and also forms the circuit path carrying the current which flows through the chamber. The conductive fluid channel 558 is routed through a magnetic “toroid” 564, thus forming one “turn” of a secondary winding. The toroid 564 is actually depicted as a more rectilinear closed magnetic core structure, although any of a variety of similar shapes may be utilized, including a literal toroidal shape. A primary winding 566 is also wound around the toroid 564. The turns ratio may be selected based upon the power supply circuit utilized, the desired output current level, the details of the magnetic core structure, and other factors. In other embodiments, the conductive fluid channel 558 may be formed to include one or more additional turns around the toroid 564, giving rise to a secondary winding having 2 or more turns.

A useful MFD pump having a conductive fluid electrode may be generalized as shown in FIG. 20. Such an MFD pump 600 includes a flow chamber 602 through which the conductive fluid is caused to flow (either into or out of the page) by the electromagnetic force exerted upon the fluid. A magnetic field is created in the flow chamber 602 by a magnetic structure 604 above the flow chamber 602 (and optionally by a second magnetic structure 606 below the flow chamber 602). The electrodes on either side of the flow chamber 602 and the closed circuit path through which the current through the flow chamber 602 flows is formed by a conductive fluid channel 608. The conductive fluid channel 608 may open directly into the flow chamber 602 (as depicted) in which case the conductive fluid channel 608 is operably filled with the same conductive fluid that flows through the pump 600 (even though the conductive fluid with the conductive fluid channel 608 is not cause to move), which eliminates any contact resistance between the “electrodes” and the conductive fluid within the pump. Alternatively, the conductive fluid channel 608 may be filled with the same or another conductive fluid, and the ends of the conductive fluid channel 608 sealed with a conductive barrier.

The current which flows through the conductive fluid channel 608 and thus across the flow chamber 602 may be generated by an inductive circuit 610, such as a transformer as shown in previous embodiments. Alternatively, a current may be induced in the conductive fluid channel 608 by an inductive coil formed around the conductive fluid channel 608, or by other inductive means.

In the various described embodiments, the various fluid paths, such as conductive fluid path 210, and portions of the electromagnetic pumps themselves may be constructed of polymer materials such as Teflon® or polyurethane. Alternatively, refractory metals such as tungsten, vanadium or molybdenum may also be used as the material of construction. Polymers like Teflon® prove to be good conduit materials as they are inert to most chemicals, provide low resistance to flow of liquids and are resistant to high temperature corrosion, and can be easily machined. Certain metallic structures, such as nickel-coated copper, can also be used. Useful configurations and construction details of the source exchanger 202 and thermal dissipater 204 are described in the above-referenced U.S. Pat. No. 6,658,861, the disclosure of which is hereby incorporated by reference in its entirety.

In certain applications, the system may need to be provided with electromagnetic interference (EMI) shielding to shield other devices in the system from electromagnetic radiations generated by the MFD pump(s). These electromagnetic radiations, if not shielded, might adversely affect the performance of other devices. Accordingly, the electromagnetic pump of the module 100 may be enclosed within a housing that provides EMI shielding. This EMI shielding may be provided using standard methods such as magnetic shields and EMI shielding tapes, and which shielding may be made using high magnetic permeability materials such as steel, nickel, alnico, or permandur or other specially processed materials.

In some embodiments, the conductive fluid may be a liquid metal, and further may be an alloy of gallium (Ga) and indium (In). Preferred compositions comprise 65 to 75% by mass gallium and 20 to 25% indium. Materials such as tin, copper, zinc and bismuth may also be present in small percentages. One such preferred composition comprises 66% gallium, 20% indium, 11% tin, 1% copper, 1% zinc and 1% bismuth. Some examples of the commercially available GaIn alloys include Galistan, which is popular as a substitute for mercury (Hg) in medical applications, and Newmerc. The various properties of a GaIn alloy make it a desirable liquid metal for use in closed circulation heat dissipation systems, such as depicted in FIG. 4. The GaIn alloy can be chosen to span a wide range of temperature with high thermal and electrical conductivities. It has melting points ranging from—15° C. to 30° C. and does not form vapor at least up to 2000° C. It is not toxic and is relatively inexpensive, and easily forms alloys with aluminum and copper. It is inert to polyimides, polycarbonates, glass, alumina, Teflon®, and conducting metals such as tungsten, molybdenum, and nickel, thereby making these materials suitable for construction of tubes, conduits, and/or channels.

It should be apparent to one of ordinary skill in the art that a number of other liquid metals may be used. For example, liquid metals having high thermal conductivity, high electrical conductivity and high volumetric heat capacity can also be used. Some examples of liquid metals that can be used in an embodiment of the invention include mercury, gallium, sodium potassium eutectic alloy (78% sodium, 22% potassium by mass), bismuth tin alloy (58% bismuth, 42% tin by mass), bismuth lead alloy (55% bismuth, 45% lead) etc. Bismuth based alloys are generally used at high temperatures (40 to 140.degree.C.). Pure indium can be used at temperatures above 156° C. (i.e., the melting point of indium), and mercury, bismuth, and gallium may also be used. Certainly other conductive fluids may be used to advantage, as well.

One or more of the various embodiments described herein may be used to efficiently provide an output voltage of less than 500 millivolts when coupled to an electromagnetic pump, and in some embodiments an output voltage of less than 250 millivolts, and in still others an output voltage less than 100 millivolts. One or more of the various embodiments described herein may be used to efficiently provide an output current of at least 5 amps when coupled to an electromagnetic pump, and in some embodiments an output current of at least 10 amps. In some embodiments, the output voltage (e.g., across an electromagnetic pump) may be at least 100 times smaller than an operating power supply voltage provided to the power supply circuit. In some embodiments, the output current (e.g., through an electromagnetic pump) may be at least 100 times larger than an operating current drawn from a power supply provided to the power supply circuit. For example, certain embodiments may be configured to provide an output current of 20 A through the electromagnetic pump while only generating a voltage of 20 mV across the electromagnetic pump, and yet the power supply circuit may draw less than 200 mA from a power supply of 2 V or more.

Several configurations of MFD pumps (also described as magnetohydrodynamic pumps) are described in the above-referenced U.S. application Ser. No. 10/443,190 entitled “Direct Current Magnetohydrodynamic Pump Configurations”. Useful pump configurations, particularly relating to techniques for creating the magnetic flux within the pump chamber, are described in co-pending U.S. Provisional Application No. 60/610,815 entitled “Magnetofluiddynamic Pumps Technology,” filed on Sep. 17, 2004, which application is hereby incorporated by reference in its entirety. Still other useful configurations are described in U.S. Provisional Application No. 60/611,115 entitled “Magnetofluiddynamic Pump Configuration Utilizing Conductive Fluid Electrode Channel,” filed on Sep. 17, 2004, which application is hereby incorporated by reference in its entirety.

As used herein, coupled may mean coupled indirectly or directly. A periodic signal need not be sinusoidal. An asymmetric current through a device conducts in one direction more than in an opposite direction, including the case that it conducts only in one direction (e.g., a unipolar current). A pulsed unipolar current includes a non-uniform unipolar current, including (but not requiring) the case when the value of the current between “pulses” is substantially zero. A first direction that is generally perpendicular to a second direction may include angles therebetween in the range of approximately 60° to 120° (i.e., a significant vector component which is perpendicular). A first direction that is substantially perpendicular to a second direction may include angles therebetween in the range of approximately 80° to 100°.

While certain embodiments of the invention have been illustrated and described, it should be clear that the invention is not to be limited to these embodiments only. The inventive concepts described herein may be used alone or in various combinations. Numerous modifications, changes, variations, substitutions, and equivalents will be apparent to those of ordinary skill in the art without departing from the spirit and scope of the invention, which is defined in the following appended claims.

What is claimed is:

1. A module comprising an electromagnetic pump and a power supply circuit coupled to the electromagnetic pump.

2. The module as recited in claim 1 wherein the power supply circuit comprises a DC-DC converter type circuit.

3. The module as recited in claim 1 wherein the power supply circuit comprises an AC-DC converter type circuit.

4. The module as recited in claim 1 wherein the electromagnetic pump comprises:
a chamber through which a conductive fluid may flow in a fluid flow direction;
means for creating within the chamber a magnetic field oriented in a direction generally perpendicular to the fluid flow direction; and
a pair of electrodes disposed on opposing sides of the chamber, said electrodes oriented such that a current flowing between said electrodes flows in a direction that is generally perpendicular to both the magnetic field direction and to the fluid flow direction.

5. The module as recited in claim 4 wherein the current flow direction is substantially perpendicular to both the magnetic field direction and the fluid flow direction.

6. The module as recited in claim 4 wherein the means for creating a magnetic field within the chamber comprises an electromagnet.

7. The module as recited in claim 4 wherein the means for creating a magnetic field within the chamber comprises at least one permanent magnet.

8. The module as recited in claim 7 wherein the means for creating a magnetic field within the chamber comprises a pair of permanent magnets respectively coupled to opposite sides of the chamber.

9. The module as recited in claim 4 wherein the power supply circuit comprises a flyback circuit configuration.

10. The module as recited in claim 4 wherein the power supply circuit comprises a buck converter circuit configuration.

11. The module as recited in claim 4 wherein the power supply circuit comprises a forward converter circuit configuration.

12. The module as recited in claim 4 wherein the power supply circuit includes no rectifying device in series with the electromagnetic pump, but which power supply circuit includes a second secondary winding having a rectifying device.

13. The module as recited in claim 4 wherein the power supply circuit is configured for operably providing a voltage less than 100 millivolts across the electromagnetic pump and a current greater than 10 amps through the electromagnetic pump.

14. The module as recited in claim 4 wherein the power supply circuit is configured for operably providing a voltage across the electromagnetic pump that is at least 100 times smaller than an operating power supply voltage provided to the power supply circuit.

15. The module as recited in claim 4 wherein the power supply circuit is configured for operably providing a current through the electromagnetic pump that is at least 100 times larger than an operating current drawn from a power supply provided to the power supply circuit.

16. The module as recited in claim 4 further comprising:
a second electromagnetic pump coupled to the power supply circuit.

17. The module as recited in claim 16 wherein the power supply circuit comprises a full-bridge circuit.

18. The module as recited in claim 16 wherein the power supply circuit comprises a half-bridge circuit.

19. The module as recited in claim 16 wherein the power supply circuit comprises a closed core with a primary winding and two secondary windings, each respective secondary winding coupled in series to a respective switch device controlled to only conduct current therein during at most a respective half-cycle, and further respectively coupled to a respective one of the electromagnetic pumps.

20. The apparatus as recited in claim 19 wherein respective operational currents through the first and second electromagnetic pumps are substantially out-of-phase with each other.

21. The module as recited in claim 19 wherein each of the secondary winding comprises no more than 2 turns.

22. The module as recited in claim 21 wherein each of the secondary winding comprises no more than 1 turn.

23. The module as recited in claim 22 wherein:
the closed core comprises a toroid; and
each respective secondary winding comprises a respective conductor passing through but not looped around the toroid, and then coupled in series to the respective switch device and to the respective electromagnetic pump.
